(19) United States
(12) Patent Application Publication
(10) Pub. No.: US 2006/0204052 A1
(43) Pub. Date: Sep. 14, 2006

(54) Method, apparatus, and program for detecting red eye

(75) Inventor: Kouji Yokouchi, Kanagawa-ken (JP)

Correspondence Address: SUGHRUE MION, PLLC, 2100 PENNSYLVANIA AVENUE, N.W., SUITE 800, WASHINGTON, DC, 20037, US

(73) Assignee: FUJI PHOTO FILM CO., LTD.

(21) Appl. No.: 11/373,439

(22) Filed: Mar. 13, 2006

(30) Foreign Application Priority Data
Mar. 11, 2005 (JP) 069529/2005

(51) Int. Cl. G06K 9/00

(52) U.S. Cl. 382/117

(57) ABSTRACT

A process for detecting red eyes within faces included within photographic images and the like includes the steps of: detecting red eye candidates, which may be estimated to be red eyes, by searching the entire image (red eye candidate detecting process); detecting a face that includes the detected red eye candidates, by searching the vicinity of the red eye candidates (face detecting process); estimating which of the red eye candidates are red eyes, by searching within search regions in the vicinities of the red eye candidates at a higher accuracy than that employed during detection of the red eye candidates (red eye estimating process); and confirming whether the results of the red eye estimating process are correct, by judging whether the red eye candidates estimated to be red eyes are the corners of eyes.

### BACKGROUND OF THE INVENTION

1. Field of the Invention

The present invention relates to a method, an apparatus, and a program for detecting the positions of eyes within images, in which red eye phenomena are present.

2. Description of the Related Art

There are cases in which pupils (or portions of pupils) of people or animals, photographed by flash photography at night or in dark places, are photographed as being red or gold. For this reason, various methods for correcting the color of pupils, which have been photographed as being red or gold (hereinafter, cases in which pupils are photographed as being gold are also referred to as “red eye”), to normal pupil colors by digital image processing have been proposed.

For example, Japanese Unexamined Patent Publication No. 2000-013680 discloses a method and apparatus for automatically discriminating red eyes. This method and apparatus automatically discriminate red eyes based on colors, positions, and sizes of pupils within a region specified by an operator. Japanese Unexamined Patent Publication No. 2001-148780 discloses a method wherein: predetermined characteristic amounts are calculated for each pixel within a region specified by an operator; and portions having characteristics that correspond to pupil portions are selected as targets of correction. However, in discriminating processes which are based solely on characteristics of pupil portions, it is difficult to discriminate targets having local redness, such as red lighting, from red eyes. For this reason, it is difficult for this process to be executed automatically, without operator intervention.

On the other hand, Japanese Unexamined Patent Publication No. 2000-125320 discloses a method wherein: faces are detected first; and red eye detection is performed within regions detected to be faces. In this method, false positives, such as red lights being detected as red eyes, does not occur. However, if errors occur during face detection, red eyes cannot be accurately detected. Therefore, the accuracy of the facial detection becomes an issue.

The simplest method for detecting faces is to detect oval skin colored regions as faces. However, people's faces are not necessarily uniform in color. Therefore, it is necessary to broadly define “skin color”, which is judged to be the color of faces. However, the possibility of false positive detection increases in the case that the range of colors is broadened in a method that judges faces based only on color and shape. For this reason, it is preferable that faces are judged utilizing finer characteristics than just the color and the shapes thereof, in order to improve the accuracy of facial detection. However, if characteristics of faces are extracted in detail, the time required for facial detection processes greatly increases.

That is, the method disclosed in Japanese Unexamined Patent Publication No. 2000-125320 is capable of detecting red eyes with high accuracy, yet gives no consideration to processing time. In the case that the method is applied to an apparatus having comparatively low processing capabilities (such as a low cost digital camera), the apparatus cannot function practically.

A method may be considered, in which red eye candidates are detected with comparatively less stringent conditions, in order to detect red eyes in a short amount of time with a small amount of calculations. Then, faces are detected in the vicinities of the detected red eye candidates. Thereafter, red eyes are confirmed within the detected facial regions, by judging the red eye candidates with conditions more stringent than those employed during detection of the red eye candidates. According to this method, first, the red eye candidates are detected, then the faces are detected in the vicinities thereof. Therefore, faces can be detected in a short amount of time and with high accuracy. Thereafter, red eyes are confirmed within the detected facial regions, by judging the red eye candidates with conditions more stringent than those employed during detection of the red eye candidates. Therefore, red eyes can be detected efficiently.

The purpose of red eye detection is to correct the detected red eyes to the original colors of pupils. Therefore, whether the detected red eyes are true red eyes greatly influences the impression given by an image following correction. A method may be considered, in which an operator confirms whether the detected red eyes are true red eyes. However, this method is time consuming, and would increase the burden on the operator. Accordingly, it is desired for confirmation of the detection results to be performed automatically.

There are cases in which the whites of the eyes are pictured red, as factors that cause false positive detection in red eye detection. That is, there are cases in which the corners of the eyes, which should be pictured white, are pictured red. If the corners of the eyes are erroneously detected as red eyes, correction would fill the whites of the eyes such that they are colored black, which would appear even more unnatural than red eye. That is, there are people, for whom the red portions at the interiors of the corners of the eyes (portions denoted by A and B in FIG. 31) are as large as the pupils. For these people, the corners of the eyes being pictured red is the greatest factor for false positive detection of red eyes.

### SUMMARY OF THE INVENTION

The present invention has been developed in view of the foregoing circumstances. It is an object of the present invention to provide a red eye detecting method, a red eye detecting apparatus, and a red eye detecting program that prevent false positive detection of red eyes.

The red eye detection method of the present invention comprises the steps of:

detecting red eye candidates, by discriminating characteristics inherent to pupils, of which at least a portion is displayed red, from within an image;

detecting faces that include the red eye candidates, by discriminating characteristics inherent to faces, from among characteristics of the image in the vicinities of the red eye candidates;

estimating that the red eye candidates included in the detected faces are red eyes; and

confirming the results of estimation, by judging whether the red eye candidates are the corners of eyes.

The estimation of red eyes from among the red eye candidates may be performed by:

discriminating characteristics inherent to pupils, of which at least a portion is displayed red, from the characteristics of the image in the vicinities of the red eye candidates at a higher accuracy than that employed during the detection of the red eye candidates; and

estimating that the red eye candidates having the characteristics are red eyes.

The red eye candidates may be detected by:

setting judgment target regions within the image;

obtaining characteristic amounts that represent characteristics inherent to pupils having regions displayed red from within the judgment target regions;

calculating scores according to the obtained characteristic amounts; and

judging that the image within the judgment target region represents a red eye candidate when the score is greater than or equal to a first threshold value. In this case, the results of estimation may only be confirmed for red eye candidates, of which the score is less than a second threshold value, which is greater than the first threshold value.

During the judgment, dark pupils may be detected within the detected facial region. In the case that dark pupils are detected, the red eye candidates, which have been estimated to be red eyes, may be judged too be the corners of eyes.

In this case, the detection of dark pupils may be performed by:

defining characteristic amounts that represent likelihood of being a dark pupil, a score table, and a threshold value, by learning sample images of dark pupils and sample images of subjects other than dark pupils, with a machine learning technique;

calculating the characteristic amounts from within the judgment target regions;

calculating scores corresponding to the characteristic amounts according to the score table; and

detecting dark pupils, by judging that the image within the judgment target region represents a dark pupil when the score is greater than or equal to the threshold value.

Alternatively, during judgment, a pixel value profile may be obtained, of pixels along a straight line that connects two red eye candidates, which have been estimated to be red eyes; and

the judgment regarding whether the red eye candidates are the corners of eyes may be performed employing the pixel value profile.

In this case, the judgment may be performed by confirming which profile the pixel value profile is, from among: a profile in the case that the two red eye candidates are true red eyes; a case that the two red eye candidates are the inner corners of eyes; and a case that the two red eye candidates are the outer corners of eyes.

The red eye detecting apparatus of the present invention comprises:

red eye candidate detecting means for detecting red eye candidates, by discriminating characteristics inherent to pupils, of which at least a portion is displayed red, from within an image;

face detecting means for detecting faces that include the red eye candidates, by discriminating characteristics inherent to faces, from among characteristics of the image in the vicinities of the red eye candidates;

red eye estimating means for estimating that the red eye candidates included in the detected faces are red eyes; and

result confirming means for confirming the results of estimation, by judging whether the red eye candidates are the corners of eyes.

A configuration may be adopted, wherein:

the red eye estimating means discriminates characteristics inherent to pupils, of which at least a portion is displayed red, from the characteristics of the image in the vicinities of the red eye candidates at a higher accuracy than that employed during the detection of the red eye candidates; and estimates that the red eye candidates having the characteristics are red eyes.

A configuration may be adopted, wherein the red eye candidate detecting means detects red eye candidates by:

setting judgment target regions within the image;

obtaining characteristic amounts that represent characteristics inherent to pupils having regions displayed red from within the judgment target regions;

calculating scores according to the obtained characteristic amounts; and

judging that the image within the judgment target region represents a red eye candidate when the score is greater than or equal to a first threshold value; and

the result confirming means confirms the results of estimation only for red eye candidates, of which the score is less than a second threshold value, which is greater than the first threshold value.

A configuration may be adopted, wherein:

the result confirming means further comprises dark pupil detecting means for detecting dark pupils within the face region detected by the face detecting means; and

the judgment regarding whether the red eye candidates, which have been estimated to be red eyes, are the corners of eyes is judged in the case that dark pupils are detected.

In this case, the dark pupil detecting means may detect dark pupils by:

defining characteristic amounts that represent likelihood of being a dark pupil, a score table, and a threshold value, by learning sample images of dark pupils and sample images of subjects other than dark pupils, with a machine learning technique;

calculating the characteristic amounts from within the judgment target regions;

calculating scores corresponding to the characteristic amounts according to the score table; and

judging that the image within the judgment target region represents a dark pupil when the score is greater than or equal to the threshold value.

A configuration may be adopted, wherein:

the result confirming means comprises a profile obtaining means for obtaining a pixel value profile of pixels along a straight line between two red eye candidates, which have been estimated to be red eyes by the red eye estimating means; and

the judgment regarding whether the red eye candidates are the corners of eyes is performed employing the pixel value profile obtained by the profile obtaining means.

In this case, the result confirming means may judge whether the red eye candidates are the corners of eyes, by confirming which profile the pixel value profile is, from among: a profile in the case that the two red eye candidates are true red eyes; a case that the two red eye candidates are the inner corners of eyes; and a case that the two red eye candidates are the outer corners of eyes.

Note that the red eye detecting method of the present invention may be provided as a program that causes a computer to execute the method. The program may be provided being recorded on a computer readable medium. Those who are skilled in the art would know that computer readable media are not limited to any specific type of device, and include, but are not limited to: floppy disks; RAM's; ROM's; CD's; magnetic tapes; hard disks; and internet downloads, by which computer instructions may be transmitted. Transmission of the computer instructions through a network or through wireless transmission means is also within the scope of the present invention. In addition, the computer instructions may be in the form of object, source, or executable code, and may be written in any language, including higher level languages, assembly language, and machine language.

According to the present invention, red eye candidates, which have been estimated to be red eyes, are judged to determined whether they are the corners of eyes. Therefore, confirmation of the estimation results is performed, and false positive detection can be prevented.

### BRIEF DESCRIPTION OF THE DRAWINGS

FIG. 1 illustrates the procedures of red eye detection in a first embodiment.

FIG. 2 illustrates an example of an image, which is a target for red eye detection.

FIG. 3 is an enlarged view of a portion of an image, which is a target for red eye detection.

FIG. 4 illustrates an example of the definition (score table) of the relationship between characteristic amounts and scores.

FIGS. 5A, 5B, 5C, 5D, and 5E illustrate examples of red eye learning samples.

FIG. 6 is a flow chart that illustrates N types of judging processes.

FIGS. 7A and 7B are diagrams for explaining the relationship between red eye detection and image resolution.

FIG. 8 is a diagram for explaining a process which is performed with respect to red eye candidates which have been redundantly detected.

FIGS. 9A and 9B illustrate examples of methods for calculating characteristic amounts.

FIG. 10 is a flow chart for explaining a second method for improving processing efficiency during red eye candidate detecting processes.

FIG. 11 is a diagram for explaining a third method for improving processing efficiency during red eye candidate detecting processes.

FIGS. 12A and 12B are diagrams for explaining a fourth method for improving processing efficiency during red eye candidate detecting processes.

FIG. 13 is a diagram for explaining a fifth method for improving processing efficiency during red eye candidate detecting processes.

FIG. 14 is a flow chart for explaining a sixth method for improving processing efficiency during red eye candidate detecting processes.

FIG. 15 is a diagram for explaining scanning of a judgment target region during face detecting processes.

FIG. 16 is a diagram for explaining rotation of a judgment target region during face detecting processes.

FIG. 17 is a flow chart that illustrates a face detecting process.

FIG. 18 is a diagram for explaining calculation of characteristic amounts during face detecting processes.

FIG. 19 is a diagram for explaining the manner in which search regions are set during red eye confirming processes.

FIG. 20 illustrates an example of a judgment target region, which is set within the search region of FIG. 19.

FIGS. 21A, 21B, and 21C illustrate examples of search regions, which are set on images of differing resolutions.

FIG. 22 is a diagram for explaining a process for confirming the positions of red eyes.

FIG. 23 is a flow chart that illustrates a red eye estimating process.

FIG. 24 is a flowchart that illustrates the processing steps of a first result confirming method.

FIG. 25 is a flow chart that illustrates the processing steps of a second result confirming method.

FIG. 26 illustrates a first example of a pixel value profile.

FIG. 27 illustrates a second example of a pixel value profile.

FIG. 28 illustrates a third example of a pixel value profile.

FIG. 29 illustrates a fourth example of a pixel value profile.

FIG. 30 illustrates an example of a red eye correcting process.

FIG. 31 is a diagram for explaining the effect that the corners of eyes have on red eye detection.

### DESCRIPTION OF THE PREFERRED EMBODIMENTS

Hereinafter, preferred embodiments of the present invention will be described with reference to the attached drawings.

[Outline of Red Eye Detecting Procedure]

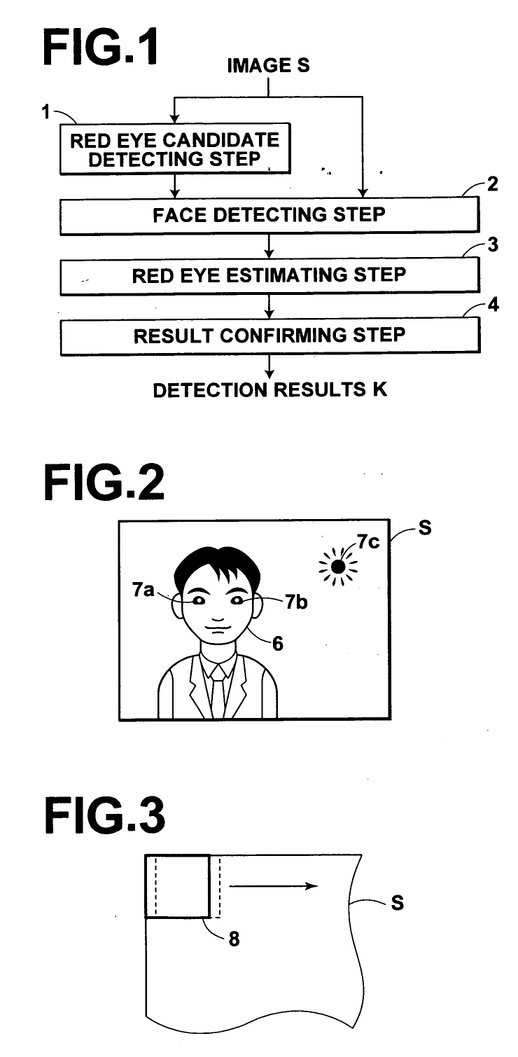

First, the outline of a red eye detecting process will be described with reference to FIG. 1 and FIG. 2. FIG. 1 illustrates the steps of red eye detection. As illustrated in FIG. 1, the present embodiment detects red eyes included in an image S, by executing a three step process, comprising a red eye candidate detecting step 1, a face detecting step 2, and a red eye estimating step 3. Thereafter, a result confirming step 4 for confirming whether the red eye candidates estimated to be red eyes are true red eyes is administered, to remove erroneously detected red eyes. Information representing whether true red eyes have been detected, and information representing the positions of red eyes, in the case that true red eyes are detected, are output as detection results K.

FIG. 2 illustrates an example of the image S. The image S is a photographic image, in which a person has been photographed with red eyes 7a and 7b. A red light 7c is also pictured in the photographic image. Hereinafter, the outline of the red eye candidate detecting step 1, the face detecting step 2 and the red eye estimating step 3 will be described for the case that the image of FIG. 2 is processed, as an example.

The red eye candidate detecting step 1 searches for portions of the image S which may be estimated to be red eyes (red eye candidates). In cases in which red eye candidates are found, the positional coordinates of the red eye candidates are recorded in a recording medium. Because red eyes, of which the sizes and orientations are unknown, are to be detected from the entirety of the image S in the red eye candidate detecting step 1, processing efficiency is prioritized above detection accuracy. In the present embodiment, the red eye candidate detecting step 1 judges that pupils exist, based only on the characteristics thereof. For this reason, in the case that the image of FIG. 2 is processed, there is a possibility that the light 7c in the background is detected as a red eye candidate, in addition to the red eyes 7a and 7b.

The face detecting step 2 searches for portions, which are estimated to be faces, from within the image S. However, the search for the faces is performed only in the peripheral regions of the red eye candidates, which have been detected in the red eye candidate detecting step 1. In the case that the red eye candidates are true red eyes, faces necessarily exist in their peripheries. In the case that portions which are likely to be faces are found during the face detecting step 2, information, such as the size of the face and the orientation thereof, are recorded in the recording medium, correlated with the red eye candidates that served as the reference points for the face search. On the other hand, in the case that no portions which are likely to be faces are found, information related to the red eye candidates that served as the reference points for the face search is deleted from the recording medium.

In the case that the image of FIG. 2 is processed, no portion which is likely to be a face is detected in the periphery of the light 7c. Therefore, information regarding the light 7c is deleted form the recording medium. A face 6 is detected in the periphery of the red eyes 7a and 7b. Accordingly, information related to the red eyes 7a and 7b are correlated with information regarding the face 6, and rerecorded in the recording medium.

The red eye estimating step 3 judges whether the red eye candidates, which have been correlated with faces in the face detecting step 2, can be estimated to be true red eyes. In the case that the candidates can be estimated to be true red eyes, their positions are also accurately confirmed.

The red eye estimating step 3 utilizes the results of the face detecting step 2. Specifically, information regarding detected faces are utilized to estimate sizes and orientations of red eyes, thereby narrowing down regions which are likely to be red eyes. Further, the positions of red eyes are estimated based on information regarding the detected faces. Then, a detection process having higher accuracy than that of the red eye candidate detecting step 1 is executed within limited regions in the peripheries of the positions.

In the case that red eye candidates are judged not to be able of being estimated as true red eyes during the red eye estimating step 3, information related to the red eye candidates is deleted from the recording medium. On the other hand, in the case that red eye candidates are judged to be able of being estimated as true red eyes, the accurate positions thereof are obtained.

The positions of red eye candidates are evaluated utilizing the information regarding the detected faces in the red eye estimating step 3. In the case that the red eye candidates are located at positions which are inappropriate for eyes within faces, information related to the red eye candidates is deleted from the recording medium.

For example, in the case that a rising sun (a red circular mark) is painted on a person's forehead, the red eye candidate detecting step 1 will detect the mark as a red eye candidate, and the face detecting step 2 will detect a face in the periphery of the mark. However, it will be judged that the red eye candidate is located in the forehead, which is an inappropriate position for eyes, during the red eye estimating step 3. Therefore, information related to the red eye candidate is deleted from the recording medium.

In the case of the image of FIG. 2, the red eye candidates 7a and 7b are estimated to be true red eyes, and accurate positions thereof are confirmed. The positions of the red eye candidates 7a and 7b are provided to the result confirming step 4.

The result confirming step 4 confirms whether the red eye candidates estimated as being red eyes by the red eye estimating step 3 are true red eyes. Specifically, the result confirming step 4 confirms the results of estimation, by judging whether the red eye candidates are actually the corners of eyes. In the case that the results of estimation by the red eye estimating step 3 are correct, the result confirming step 4 outputs results indicating that red eyes have been detected, and data representing the positions of the red eyes, obtained by the red eye estimating step 3, as detection results K. On the other hand, in the case that the results of estimation by the red eye estimating step 3 are erroneous, the result confirming step 4 outputs results indicating that red eyes have not been detected as detection results K.

An apparatus for detecting red eyes by the above process may be realized by loading a program that causes execution of each of the aforementioned steps into an apparatus comprising: a recording medium, such as a memory unit; a calculating means for executing processes defined by the program; and an input/output interface for controlling data input from external sources and data output to external destinations.

Alternatively, an apparatus for detecting red eyes by the above process may be realized by incorporating a memory/logic device, designed to execute the red eye candidate detecting step 1, the face detecting step 2, and the red eye estimating step 3, into a predetermined apparatus.

In other words, not only general use computers, but any apparatus, in which programs or semiconductor devices can be loaded, even if they are built for other specific uses, may function as an apparatus for detecting red eyes by the above process. Examples of such apparatuses are digital photographic printers and digital cameras.

[Red Eye Candidate Detecting Step 1]

Next, the red eye candidate detecting step 1 will be described in detail. During the red eye candidate detecting step 1, the red eye detecting apparatus first converts the color space of an obtained image. Specifically, the display color system of the image is converted, by replacing the R (red), G (green), and B (blue) values of each pixel in the image with Y (luminance), Cb (color difference between green and blue), Cr (color difference between green and red), and Cr* (color difference between skin color and red) by use of predetermined conversion formulas.

YCbCr is a coordinate system which is commonly utilized in JPEG images. Cr* is a coordinate axis that represents a direction in which red and skin color are best separated within an RGB space. The direction of this coordinate axis is determined in advance, by applying a linear discriminant analysis method to red samples and skin colored samples. By defining this type of coordinate axis, the accuracy of judgment, to be performed later, is improved compared to cases in which judgment is performed within a normal YCbCr space.

FIG. 3 is a magnified view of a portion of the image S, which has been color space converted. The red eye detecting apparatus sets a judgment target region 8 on the image S, as illustrated in FIG. 3. The red eye detecting apparatus examines the image within the judgment target region 8 to determine how many characteristics of red eye are present therein. In the present embodiment, the size of the judgment target region 8 is 10 pixels×10 pixels.

The determination regarding how many characteristics of red eye are present within the judgment target region 8 is performed in the following manner. First, characteristic amounts that represent likelihood of being red eyes, scores corresponding to the value of the characteristic amounts, and a threshold value are defined in advance. For example, if pixel values are those that represent red, that would be grounds to judge that red eye exists in the vicinity of the pixels. Accordingly, pixel values may be characteristic amounts that represent likelihood of being red eyes. Here, an example will be described, in which pixel values are defined as the characteristic amounts.

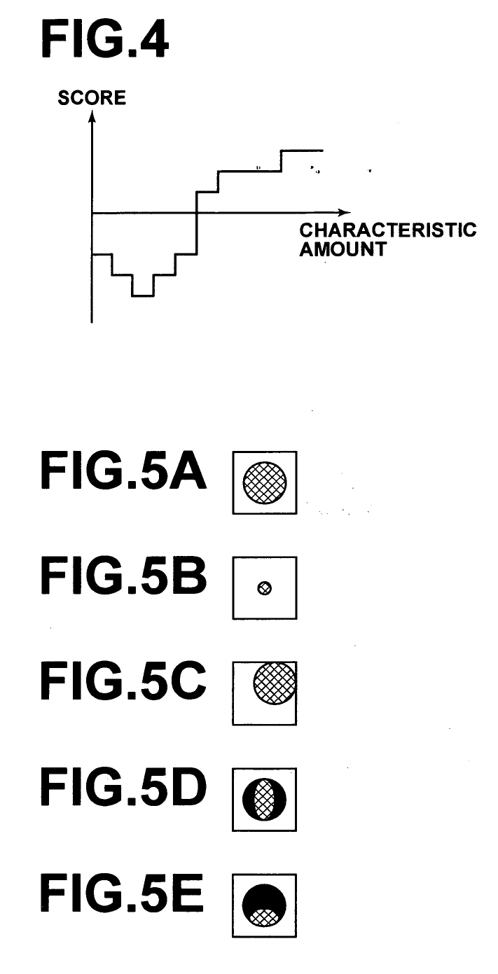

The score is an index that represents how likely red eyes exist. Correlations among scores and characteristic amounts are defined. In the case of the above example, pixel values, which are perceived to be red by all viewers, are assigned high scores, while pixel values, which may be perceived to be red by some viewers and brown by other viewers, are assigned lower scores. Meanwhile, pixel values that represent colors which are clearly not red (for example, yellow) are assigned scores of zero or negative scores. FIG. 4 is a score table that illustrates an example of the correspondent relationship between characteristic amounts and scores.

Whether the image within the judgment target region 8 represents red eyes is judged in the following manner. First, characteristic amounts are calculated for each pixel within the judgment target region 8. Then, the calculated characteristic amounts are converted to scores, based on definitions such as those exemplified in the score table of FIG. 4. Next, the scores of all of the pixels within the judgment target region 8 are totaled. If the total value of the scores is greater than or equal to the threshold value, the subject of the image within the judgment target region is judged to be a red eye. If the total value of the scores is less than the threshold value, it is judged that the image does not represent a red eye.

As is clear from the above description, the accuracy of judgment in the above process depends greatly on the definitions of the characteristic amounts, the score table, and the threshold value. For this reason, the red eye detecting apparatus of the present embodiment performs learning, employing sample images of red eyes and sample images of other subjects (all of which are 10 pixels×10 pixels). Appropriate characteristic amounts, score tables, and threshold values, which are learned by the learning process, are employed in judgment.

Various known learning methods, such as a neural network method, which is known as a machine learning technique, and a boosting method, may be employed. Images, in which red eyes are difficult to detect, are also included in the sample images utilized in the learning process.

For example, the sample images utilized in the learning process may include: standard sample images, as illustrated in FIG. 5A; images in which the size of the pupil is smaller than that of standard sample images, as illustrated in FIG. 5B; images in which the center position of the pupil is misaligned, as illustrated in FIG. 5C; and images of incomplete red eyes, in which only a portion of the pupil is red, as illustrated in FIGS. 5D and 5E.

The sample images are utilized in the learning process, and effective characteristic amounts are selected from among a plurality of characteristic amount candidates. The judgment process described above is repeated, employing the selected characteristic amounts and score tables generated therefor. The threshold value is determined so that a predetermined percentage of correct judgments is maintained during the repeated judgments.

At this time, the red eye detecting apparatus of the present embodiment performs N types of judgment (N is an integer greater than or equal to 2) on individual judgment target regions, utilizing N types of characteristic amounts, score tables, and threshold values. The coordinates of judgment target regions are registered in a red eye candidate list only in cases in which all of the N judgments judge that red eye is present. That is, the accuracy of judgment is improved by combining the plurality of types of characteristic amounts, score tables, and threshold values, and only reliable judgment results are registered in the list. Note that here, “registered in a red eye candidate list” refers to recording positional coordinate data and the like in the recording medium.

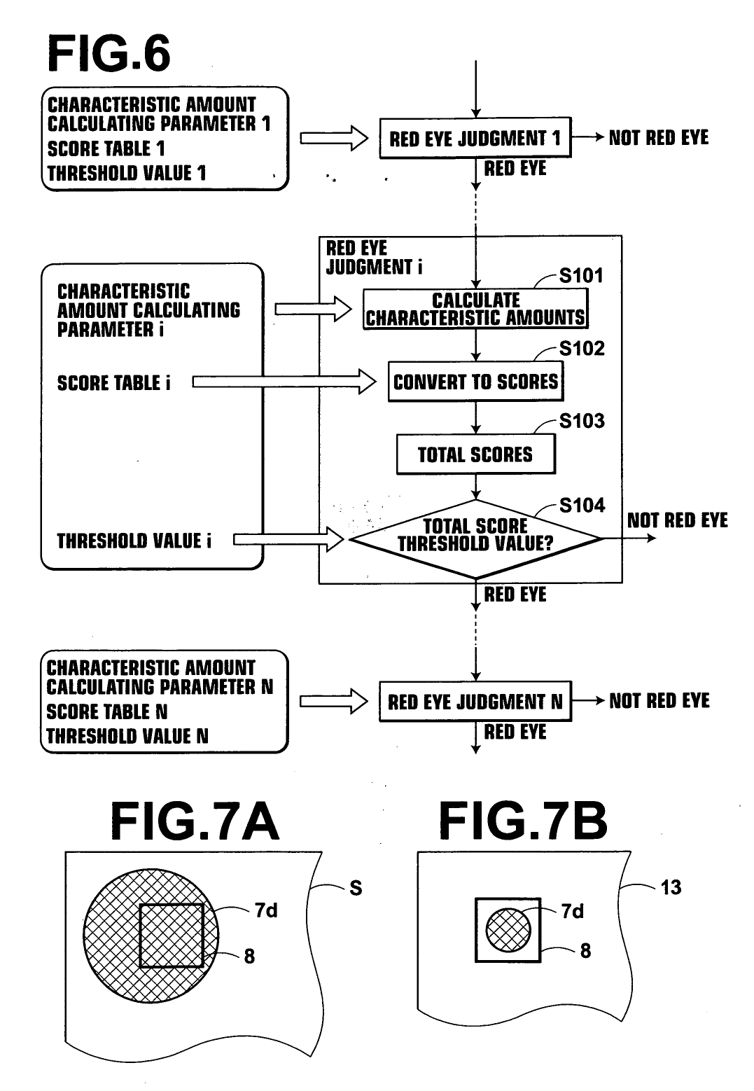

FIG. 6 is a flow chart that illustrates the N types of judgment processes. As illustrated in FIG. 6, the red eye detecting apparatus first performs a first judgment on a set judgment target region, referring to a first type of characteristic amount calculating parameters, score table and threshold value. The characteristic amount calculating parameters are parameters, such as coefficients, that define a calculation formula for characteristic amounts.

In the case that the first red eye judgment process judges that red eye exists, the same judgment target region is subjected to a second judgment, referring to a second type of characteristic amount calculating parameters, score table, and threshold value. In the case that the first red eye judgment process judges that red eye is not present, it is determined at that point that the image within the judgment target region does not represent red eye, and a next judgment target region is set.

Thereafter, in cases that red eye is judged to exist by an (i−1)^{th} judgment process (2≦i≦N), the same judgment target region is subjected to an ^{ith} judgment process, referring to an i^{th} type of characteristic amount calculating parameters, score table, and threshold value. In cases that an (i−1)^{th} judgment process judges that red eye is not present, then judgment processes for that judgment target region are ceased at that point.

Note that at each judgment, characteristic amounts are calculated for each pixel (step S101), the characteristic amounts are converted to scores (step S102), and the scores of all of the pixels within the judgment target region are totaled (step S103). If the total value of the scores is greater than or equal to the threshold value, the subject of the image within the judgment target region is judged to be a red eye; and if the total value of the scores is less than the threshold value, it is judged that the image does not represent a red eye (step S104).

The red eye detecting apparatus registers coordinates of judgment target regions in a red eye candidate list, only in cases in which an N^{th} judgment, which refers to an N^{th} type of characteristic amount calculating parameter, score table, and threshold value, judges that red eye is present.

In the judgment process described above, it is assumed that red portions included in the image S are of sizes that fit within a 10 pixel×10 pixel region. In actuality, however, there are cases in which a red eye 7d included in the image S is larger than the 10 pixel×10 pixel judgment target region 8, as illustrated in FIG. 7A. For this reason, the red eye detecting apparatus of the present embodiment performs the aforementioned judgment processes not only on the image S input thereto, but on a low resolution image S3, generated by reducing the resolution of the image S, as well.

As illustrated in FIG. 7B, if the resolution of the image S is reduced, the red eye 7d fits within the 10 pixel×10 pixel judgment target region 8. It becomes possible to perform judgments on the low resolution image S3 employing the same characteristic amounts and the like as those which were used in the judgments performed on the image S. The image having a different resolution may be generated at the point in time at which the image S is input to the red eye detecting apparatus. Alternatively, resolution conversion may be administered on the image S as necessary during execution of the red eye candidate detecting step.

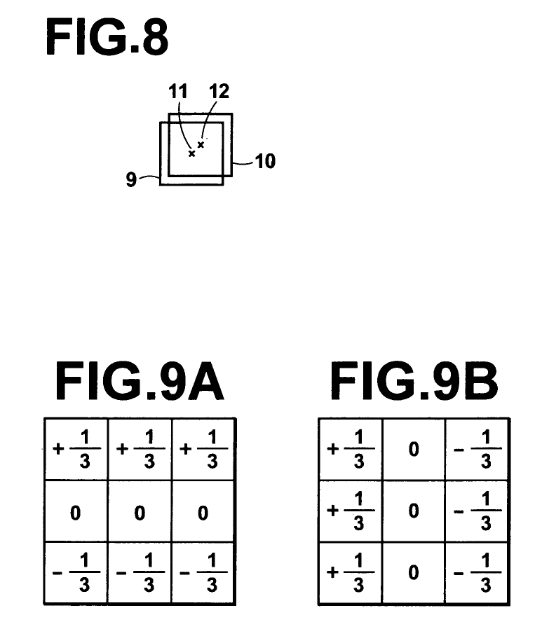

Note that judgments may be performed by moving the judgment target region 8 in small increments (for example, increments of 1 pixel each). In these cases, a single red eye may be redundantly detected by judgment processes for different judgment target regions 9 and 10, as illustrated in FIG. 8. The single red eye may be registered in the red eye candidate list as separate red eye candidates 11 and 12. There are also cases in which a single red eye is redundantly detected during detecting processes administered on images having different resolutions.

For this reason, the red eye detecting apparatus of the present embodiment confirms the coordinate information registered in the red eye candidate list after scanning of the judgment target region is completed for all images having different resolutions. In cases that a plurality of pieces of coordinate information that clearly represent the same red eye are found, only one piece of the coordinate information is kept, and the other pieces are deleted from the list. Specifically, the piece of coordinate information that represents the judgment target region having the highest score total is kept as a red eye candidate, and the other candidates are deleted from the list.

The red eye candidate list, which has been organized as described above, is output as processing results of the red eye candidate detecting step 1, and utilized in the following face detecting step 2.

In the red eye candidate detecting step of the present embodiment, processing time is reduced without decreasing the accuracy of detection. This is accomplished by adjusting the resolution of images employed in the detection, the manner in which the judgment target regions are set, and the order in which the N types of characteristic amount calculating parameters are utilized. Hereinafter, methods for improving the processing efficiency of the red eye candidate detecting step will be described further.

[Methods for Improving Red Eye Candidate Detection Efficiency]

The methods for improving the efficiency of the red eye candidate detecting step described below may be employed either singly or in combinations with each other.

A first method is a method in which characteristic amounts are defined such that the amount of calculations is reduced for judgments which are performed earlier, during the N types of judgment. As has been described with reference to FIG. 6, the red eye detecting apparatus of the present embodiment does not perform (i+1)^{th} judgment processes in cases in which the i^{th} judgment process judges that red eye is not present. This means that judgment processes, which are performed at earlier stages, are performed more often. Accordingly, by causing the processes which are performed often to be those that involve small amounts of calculations, the efficiency of the entire process can be improved.

The definition of the characteristic amounts described above, in which the characteristic amounts are defined as the values of pixels (x, y), is the example that involves the least amount of calculations.

Another example of characteristic amounts which may be obtained with small amounts of calculations is differences between pixel values (x, y) and pixel values (x+dx, y+dy). The differences between pixel values may serve as characteristic amounts that represent likelihood of being red eyes, because colors in the periphery of pupils are specific, such as white (whites of the eyes) or skin color (eyelids). Similarly, combinations of differences between pixel values (x, y) and pixel values (x+dx1, y+dy1) and differences between pixel values (x, y) and pixel values (x+dx2, y+dy2) may also serve as characteristic amounts that represent likelihood of being red eyes. Combinations of differences among four or more pixel values may serve as characteristic amounts. Note that values, such as dx, dx1, dx2, dy, dy1, and dy2, which are necessary to calculate the characteristic amounts, are recorded as characteristic amount calculating parameters.

As an example of characteristic amounts that require more calculations, averages of pixel values within a 3×3 pixel space that includes a pixel (x, y) may be considered. Combinations of differences among pixel values in the vertical direction and the horizontal direction, within a 3×3 pixel space having a pixel (x, y) at its center, may also serve as characteristic amounts. The difference among pixel values in the vertical direction may be obtained by calculating weighted averages of the 3×3 pixels, employing a filter such as that illustrated in FIG. 9A. Similarly, the difference among pixel values in the horizontal direction may be obtained by calculating weighted averages of the 3×3 pixels, employing a filter such as that illustrated in FIG. 9B. As examples of characteristic amounts that involve a similar amount of calculations, there are: integral values of pixels which are arranged in a specific direction; and average values of pixels which are arranged in a specific direction.

There are characteristic amounts that require even more calculations. Gradient directions of pixels (x, y), that is, the directions in which the pixel value (color density) changes, may be obtained from values calculated by employing the filters of FIGS. 9A and 9B. The gradient directions may also serve as characteristic amounts that represent likelihood of being red eyes. The gradient direction may be calculated as an angle θ with respect to a predetermined direction (for example, the direction from a pixel (x, y) to a pixel (x+dx, y+dy)). In addition, “Detection Method of Malignant Tumors in DR Images-Iris Filter-”, Kazuo Matsumoto et al., Journal of the Electronic Information Communication Society, Vol. J75-D-II, No. 3, pp. 663-670, 1992 discloses a method by which images are evaluated based on distributions of gradient vectors. Distributions of gradient vectors may also serve as characteristic amounts that represent likelihood of being red eyes.

A second method is based on the same principle as the first method. The second method classifies characteristic amounts in to two groups. One group includes characteristic amounts that require relatively small amounts of calculations, and the other group includes characteristic amounts that require large amounts of calculations. Judgment is performed in steps. That is, the judgment target region is scanned on the image twice.

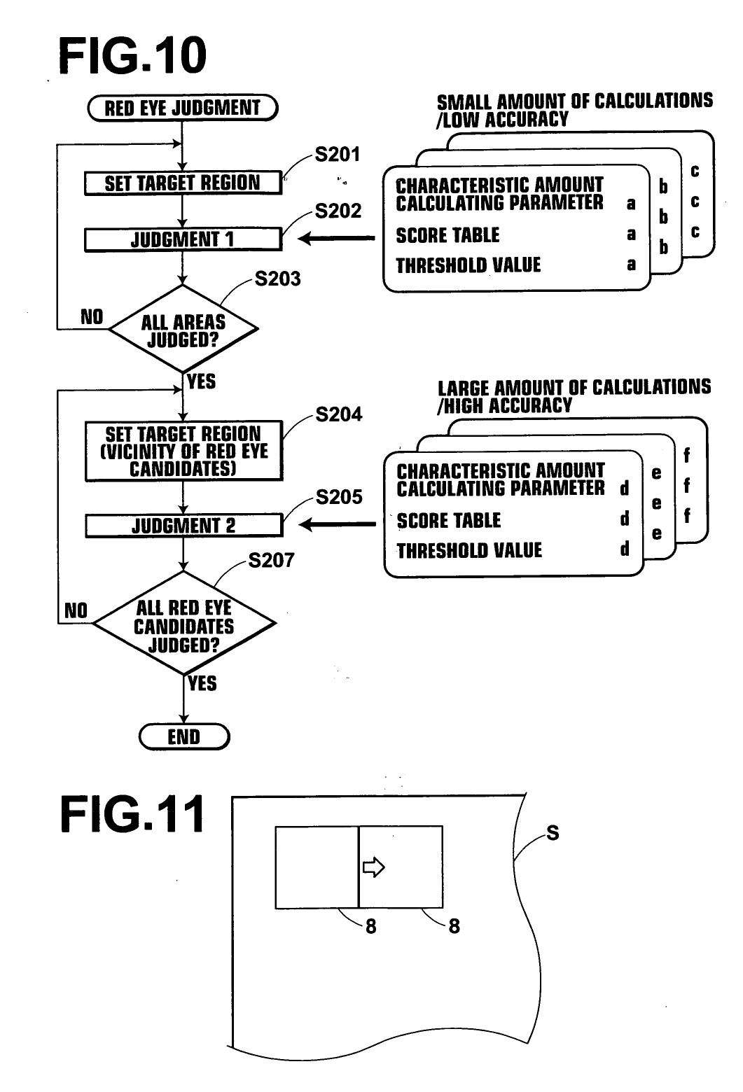

FIG. 10 is a flow chart that illustrates the judgment process in the case that the second method is employed. As illustrated in the flow chart, during the first scanning, first, the judgment target region is set (step S201). Then, judgment is performed on the judgment target region employing only the characteristic amounts that require small amounts of calculations (step S202). The judgment target region is moved one pixel at a time and judgment is repeated, until the entirety of the image is scanned (step S203). During the second scanning, judgment target regions are set at the peripheries of the red eye candidates detected by the first scanning (step S204). Then, judgment is performed employing the characteristic amounts that require large amounts of calculations (step S205). Judgment is repeated until there are no more red eye candidates left to process (step S207).

In the second method, the judgment processes employing the characteristic amounts that require large amounts of calculations are executed on a limited number of judgment target regions. Therefore, the amount of calculations can be reduced as a whole, thereby improving processing efficiency. In addition, in the second method, the judgment results obtained by the first scanning may be output to a screen or the like prior to performing the second detailed judgment. That is, the amount of calculations in the first method and in the second method is substantially the same. However, it is preferable to employ the second method, from the viewpoint of users who observe reaction times of the red eye detecting apparatus.

Note that the number of groups that the characteristic amounts are classified in according to the amount of calculations thereof is not limited to two groups. The characteristic amounts may be classified into three or more groups, and the judgment accuracy may be improved in a stepwise manner (increasing the amount of calculations). In addition, the number of characteristic amounts belonging to a single group may be one type, or a plurality of types.

A third method is a method wherein the judgment target region is moved two or more pixels at a time during scanning thereof, as illustrated in FIG. 11, instead of one pixel at a time. FIG. 11 illustrates an example in which the judgment target region is moved in 10 pixel increments. If the total number of judgment target regions decreases, the amount of calculations as a whole is reduced, and therefore processing efficiency can be improved. Note that in the case that the third method is employed, it is preferable that learning is performed using a great number of sample images, in which the centers of red eyes are misaligned, such as that illustrated in FIG. 5C.

A fourth method is a method wherein judgment processes are performed on a lower resolution image first. Judgment target regions are relatively larger with respect to lower resolution images as compared to higher resolution images. Therefore, larger portions of the image can be processed at once. Accordingly, judgment is performed on a lower resolution image first, and regions in which red eyes are clearly not included are eliminated. Then, judgment is performed on a higher resolution image only at portions that were not eliminated by the first judgment.

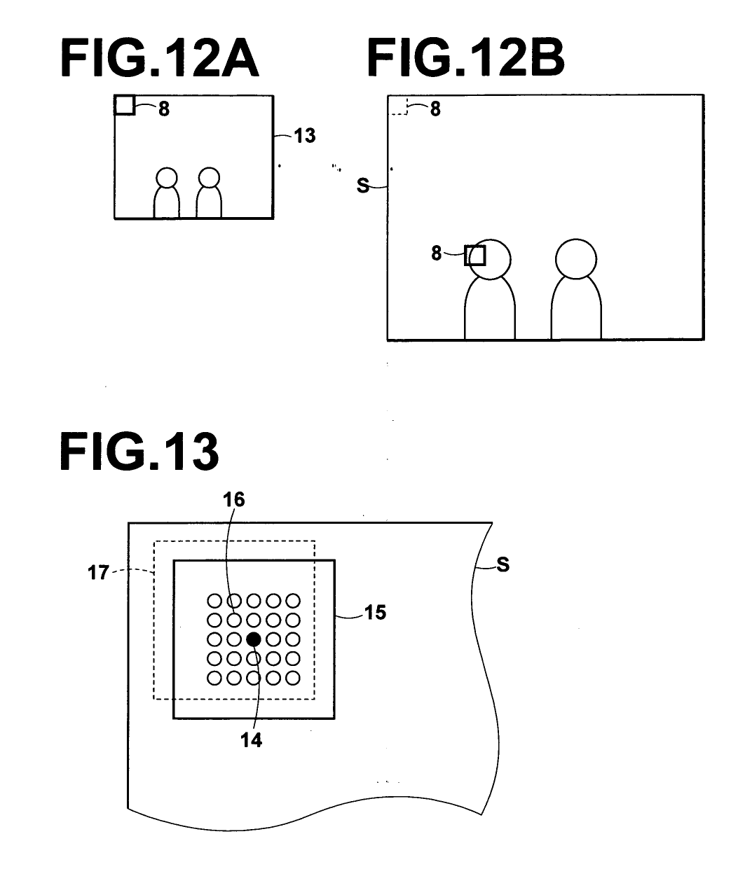

The fourth method is particularly effective for images in which people with red eyes are pictured at the lower halves thereof, and dark nightscapes are pictured at the upper halves thereof. FIG. 12A and FIG. 12B illustrate an example of such an image. FIG. 12A illustrates a low resolution image S3, and FIG. 12B illustrates a high resolution image S, which was input to the red eye detecting apparatus.

As is clear from FIG. 12A and FIG. 12B, if the judgment target region 8 is scanned over the entirety of the low resolution image S3 first, the upper half of the image that does not include red eyes can be eliminated as red eye candidates by a process that involves small amounts of calculations. Therefore, the judgment target region 8 is scanned over the entirety of the low resolution image S3, and red eye candidates are detected. Then, a second candidate detection process is performed on the image S, only in the peripheries of the detected red eye candidates. Thereby, the number of judgments can be greatly reduced. Note that in the case that this method is employed, it is preferable that learning is performed using a great number of sample images, in which the red eyes are small, such as that illustrated in FIG. 5B.

Next, a fifth method, which is effective if used in combination with the third or the fourth method, will be described with reference to FIG. 13. The third and fourth methods are capable of quickly narrowing down red eye candidates with small amounts of calculations. However, the detection accuracy of the positions of the detected red eye candidates is not high. Therefore, the fifth method searches for red eye candidates in the vicinities of the narrowed down red eye candidates. In the case that the fourth method is employed, the search for red eye candidates in the vicinities of the red eye candidates is performed on the higher resolution image.

For example, consider a case in which a red eye candidate having a pixel 14 at its center is detected by the third or fourth method. In this case, a judgment target region 15 is set so that the pixel 14 is at the center thereof. Then, judgment is performed employing the same characteristic amounts, score table, and threshold value as the previous judgment, or by employing characteristic amounts, score table, and threshold value having higher accuracy. Further, a highly accurate judgment is also performed within a judgment target region 17, having a pixel 16, which is adjacent to the pixel 14, at the center thereof.

In a similar manner, judgment target regions are set having the other 7 pixels adjacent to the pixel 14 at the centers thereof, and judgments regarding whether red eye exists therein are performed. Alternatively, judgment may be performed on the 16 pixels that are arranged so as to surround the 8 pixels adjacent to the pixel 14. As a further alternative, a plurality of judgment target regions that overlap at least a portion of the judgment target region 15 may be set, and judgment performed thereon.

In the case that a different red eye candidate is detected during the search of the peripheral region of the red eye candidate, the coordinates of the different red eye candidate (for example, the coordinates of the pixel 16) are added to the list. By searching the peripheral region of the red eye candidate in detail, the accurate position of the red eye candidate may be obtained.

Note that in this case, a single redeye is redundantly detected. Therefore, the aforementioned organization is performed after searching is complete. Specifically, coordinates of the judgment target region having the highest score total, from among the coordinates which have been judged to be red eyes and added to the list, is kept as a red eye candidate, and the other coordinates are deleted from the list.

Note that in the fifth method, the accuracy of judgment is increased over the previous judgment when searching for red eye candidates within the narrowed down regions. Thereby, the positional accuracy of the detected red eye candidates is improved. A sixth method, to be described below, is applicable to cases in which the judgment accuracy of the second and following judgments is desired to be improved over that of previous judgments.

In the sixth method, characteristic amounts are classified into two groups, in the same manner as in the second method. One group includes characteristic amounts that require relatively small amounts of calculations, and the other group includes characteristic amounts that require large amounts of calculations.

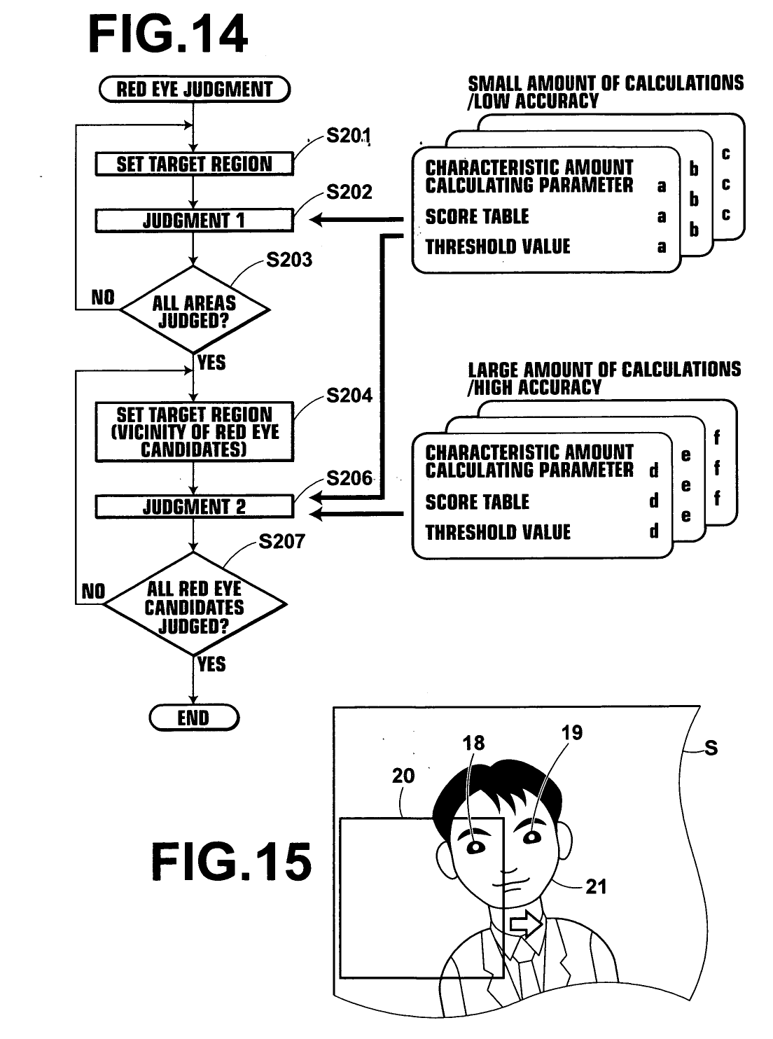

FIG. 14 is a flow chart that illustrates the judgment process in the case that the sixth method is employed. As illustrated in the flow chart, during the first scanning, first, the judgment target region is set (step S201). Then, judgment is performed on the judgment target region employing only the characteristic amounts that require small amounts of calculations (step S202). The judgment target region is moved two pixels at a time as described in the third method, and judgment is repeated until the entirety of the image is scanned (step S203). Alternatively, the first scanning may be performed on a lower resolution image, as described in the fourth method.

During the second scanning, judgment target regions are set in the peripheries of the red eye candidates, which have been detected by the first scanning, as described in the fifth method (step S204). Then, judgments are performed (step S206) until there are no more red eye candidates left to process (step S207). Both characteristic amounts that require small-amounts of calculations and those that require large amounts of calculations are employed during the judgments of step S206. However, during the judgment of step S206 employing the characteristic amounts that require small amounts of calculations, the threshold values are set higher than during the judgment of step S202. Specifically, the threshold value is set low during the judgment of step S202, to enable detection of red eyes which are located at positions off center within the judgment target regions. On the other hand, the judgment of step 206 sets the threshold value high, so that only red eyes, which are positioned at the centers of the judgment target regions, are detected. Thereby, the positional accuracy of the red eyes detected in step S206 is improved.

Note that the number of groups that the characteristic amounts are classified in according to the amount of calculations thereof is not limited to two groups. The characteristic amounts may be classified into three or more groups, and the judgment accuracy may be improved in a stepwise manner (increasing the amount of calculations). In addition, the number of characteristic amounts belonging to a single group may be one type, or a plurality of types.

The red eye detecting apparatus of the present embodiment employs the above methods either singly or in combination during detection of red eye candidates. Therefore, red eye candidates may be detected efficiently.

[Face Detecting Step 2]

Next, the face detecting step 2 will be described. The face detecting step 2 sets judgment target regions within the image, and searches to investigate how many characteristics inherent to faces are present in the images within the judgment target regions, in a manner similar to the red eye candidate detecting step 1. The face detecting step 2 is basically the same as the eye detecting algorithm of the red eye candidate detecting step 1. Specifically, the two steps are similar in that: learning employing sample images is performed in advance, to select appropriate characteristic amounts, score tables and the like; optimal threshold values are set based on the learning; characteristic amounts are calculated for each pixel within judgment target regions, converted to scores, the scores are totaled and compared against the threshold values; and searching is performed while varying the resolution of the image.

The face detecting step 2 does not search for faces within the entirety of the image. Instead, the face detecting step 2 employs the red eye candidates, detected by the red eye candidate detecting step 1, as reference points. That is, faces are searched for only in the peripheries of the red eye candidates. FIG. 15 illustrates a state in which a judgment target region 20 is set on an image S, in which red eye candidates 18 and 19 have been detected.

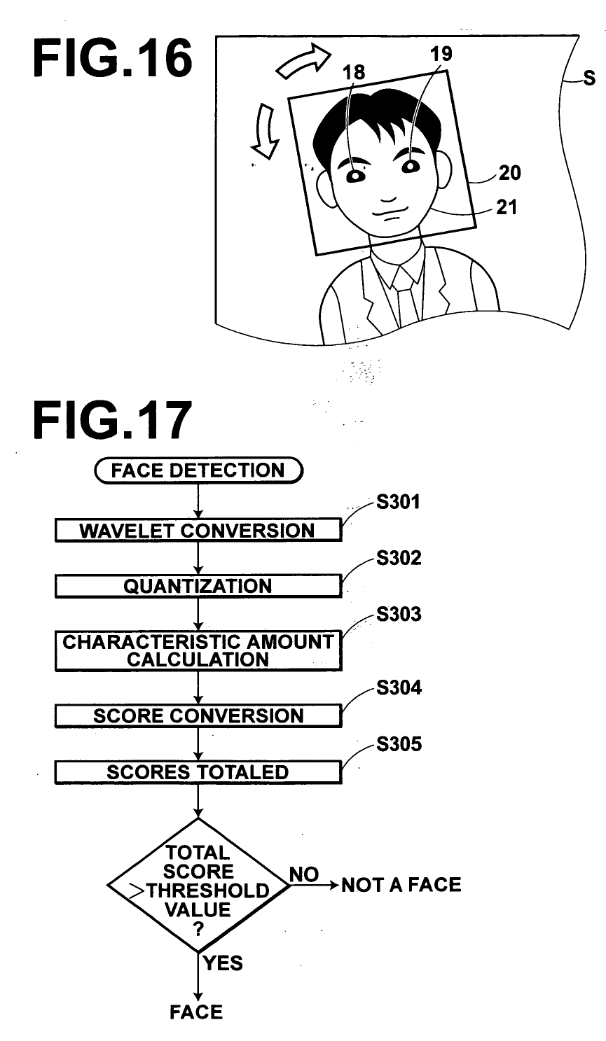

In addition, in the face detecting step 2, scanning of the judgment target region 20 is not limited to horizontal movement in the vicinities of the red eye candidates, as illustrated in FIG. 15. Searching is also performed while rotating the judgment target region 20, as illustrated in FIG. 16. This is because the values of characteristic amounts for faces vary greatly depending on the orientation of the face, unlike those for eyes (pupils). In the present embodiment, if faces are not detected with the judgment target region in a certain orientation, the judgment target region is rotated 30 degrees. Then, characteristic amounts are calculated, the characteristic amounts are converted to scores, and the totaled scores are compared against the threshold values, within the rotated judgment target region.

The face detecting step 2 judges whether faces exist within the judgment target region based on characteristic amounts, which are extracted by wavelet conversion. FIG. 17 is a flow chart that illustrates the face detecting process.

The red eye detecting apparatus first administers wavelet conversion on Y (luminance) components of the image within the judgment target region (step S301). Thereby, a ¼ size sub band image, an LL0 image, an LH0 image, an HL0 image, and an HH0 image (hereinafter, these will be collectively be referred to as “level 0 images”) are generated. In addition, a 1/16 size sub band image, an LL1 image, an LH1 image, an HL1 image, and an HH1 image (hereinafter, these will be collectively be referred to as “level 1 images”) are generated. Further, a 1/64 size sub band image, an LL2 image, an LH2 image, an HL2 image, and an HH2 image (hereinafter, these will be collectively referred to as “level 2 images”) are generated.

Thereafter, the red eye detecting apparatus employs local scattering to normalize and quantize the sub band images, which have been obtained by wavelet conversion (step S302).

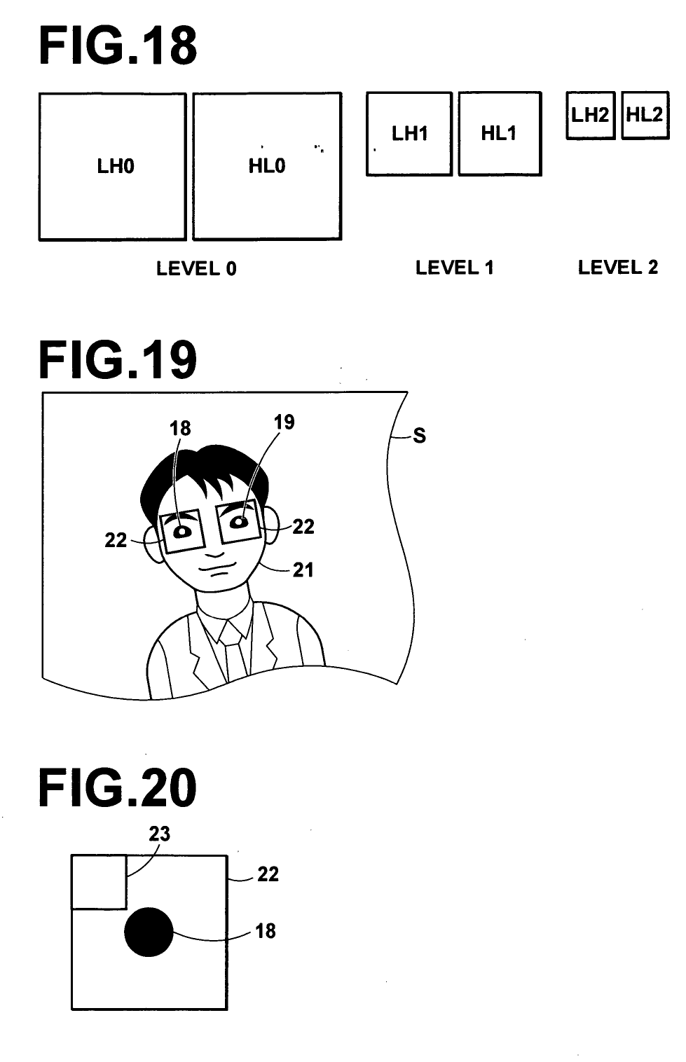

In the case that images are analyzed by wavelet conversion, LH images are obtained, in which the edges in the horizontal direction are emphasized. Further, HL images are obtained, in which the edges in the vertical direction are emphasized. For this reason, characteristic amounts are calculated from within level 0, level 1, and level 2 LH and HL images (step S303) during a face judging process, as illustrated in FIG. 18. In the present embodiment, arbitrary four point combinations of the wavelet coefficients of the LH images and the HL images are defined as characteristic amounts that represent likelihood of being faces. Next, the calculated characteristic amounts are converted to scores (step S304), the scores are totaled (step S305), and the total scores are compared against threshold values (step S306), in a manner similar to that of the red eye candidate detecting step 1. The red eye detecting apparatus judges the image within the judgment target region to be a face if the total score is greater than or equal to the threshold value, and judges that the image is not of a face if the total score is less than the threshold value.

In the case that a face is detected by the aforementioned search, the red eye detecting apparatus registers the face in a face list, correlated with the red eye candidate that served as the reference point for the search. In the example illustrated in FIG. 15 and FIG. 16, the red eye 18 and a face 21 are correlated and registered in the face list. In addition, the red eye 19 and the face 21 are correlated and registered in the face list.

In the case that the same face is redundantly detected, the registered information is organized. In the aforementioned example, information regarding the face 21, the red eye candidates 18 and 19 are consolidated into one piece of information. The consolidated information is reregistered in the face list. The face list is referred to in the red eye estimating step 3, to be described below.

[Red Eye Estimating Step 3]

Next, the red eye estimating step 3 will be described. The red eye estimating step 3 judges whether the red eye candidates, which have been correlated with faces and recorded in the face detecting step 2, can be estimated to be true red eyes. In other words, the red eye estimating step 3 investigates the detection results of the red eye candidate detecting step 1. Therefore, it is necessary that the judgment of red eye to be performed more accurately than that performed in the red eye candidate detecting step 1. Hereinafter, the red eye judgment process performed by the red eye estimating step 3 will be described.

FIG. 19 illustrates the red eye candidates 18 and 19, which have been detected from the image S by the red eye candidate detecting step 1, the face 21, which has been detected by the face detecting step 2, and search regions 22, which have been set in the image S by in the red eye estimating step 3. The objective of the red eye candidate detecting step 1 is to detect red eye candidates. Therefore, the search region for the red eye candidate detecting step 1 was the entirety of the image. In contrast, the objective of the red eye estimating step 3 is to verify the detection results of the red eye candidate detecting step 1. Therefore, the search region may be limited to the vicinities of the red eye candidates, as illustrated in FIG. 19.

During the red eye estimating step 3, the red eye detecting apparatus refers to information regarding the size and orientation of faces, obtained in the face detecting step 2. Thereby, the orientations of the red eye candidates are estimated, and the search regions are set according to the sizes and orientations of the red eye candidates. That is, the search regions are set so that the vertical directions of the pupils match the vertical directions of the search regions. In the example illustrated in FIG. 19, the search regions 22 are inclined to match the inclination of the face 21.

Next, the red eye judgment process performed within the search regions 22 will be described. FIG. 20 illustrates the search region 22 in the vicinity of the red eye candidate 18. In the red eye judgment process, judgment target regions 23 are set within the search region 22.

Thereafter, characteristic amounts are calculated for each pixel within the judgment target region 23, and the calculated characteristic amounts are converted to scores that represent likelihood of being red eyes by employing a score table, in the same manner as in the red eye candidate detecting step. Then, the red eye candidates are judged to be red eyes if the total value of the scores corresponding to each pixel within the judgment target region exceeds a threshold value. The red eye candidates are judged not to be red eyes if the total value of the scores is less than the threshold value.

The judgment target region 23 is scanned within the search region 22, and the judgment described above is performed repeatedly. In the case of the red eye estimating step 3, red eye candidates are necessarily present within the search region 22, as opposed to the red eye candidate detecting step 1. Accordingly, in the case that judgments are performed by scanning the judgment target region 23 within the search region 22, many judgment results indicating red eye should be obtained. There are cases in which the number of positive judgments indicating red eye is small, regardless of the fact that the judgments were performed by scanning the judgment target region 23 within the search region 22. In these cases, there is a possibility that the red eye candidate 18 is not a true red eye. This means that the number of times that red eye is judged to exist, during scanning of the judgment target region 23, is an effective index that represents the reliability of the detection results of the red eye candidate detecting step 1.

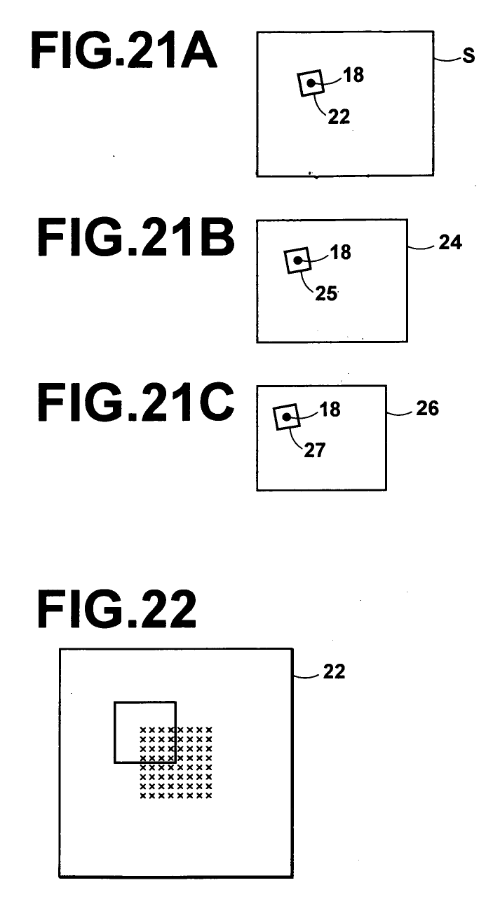

A plurality of images having different resolutions are employed during judgment of red eye in the red eye estimating step 3, in the same manner as in the red eye candidate detecting step 1. FIGS. 21A, 21B, and 21C illustrate states in which search regions 22, 25, and 27, all of the same size, are respectively set in the vicinity of the red eye candidate 18, within images S, 24, and 26, which are of different resolutions.

The resolutions of images are finely varied in the red eye estimating step 3, unlike in the red eye candidate detecting step 1. Specifically, the resolution is changed so that the image 24 of FIG. 21B has about 98% of the number of pixels of the image S of FIG. 21A, and so that the image 26 of FIG. 21C has about 96% of the number of pixels of the image S of FIG. 21A.

In the examples illustrated in FIGS. 21A, 21B, and 21C, there should not be a great difference in the number of positive judgments of red eye between judgments performed by scanning the judgment target region within the search region 22 and those performed by scanning the judgment target region within the search region 27. Accordingly, in the case that the number of positive judgments of red eye in the search region 22 is high while the number of positive judgments in the search region 27 is low, there is a possibility that the red eye candidate is not a true red eye. In this manner, the number of positive judgments during judgment of images having different resolutions also serves to represent the reliability of the detection results of the red eye candidate detecting step 1.

In the red eye estimating step 3 of the present embodiment, the number of times that red eye was judged to exist within each search region and the number of times that red eye was judged to exist in the images having different resolutions are totaled. This total number is set to be the number of times that the red eye candidate, which served as the reference point for the search regions, was judged to be red eye. If this total number is greater than a predetermined number, it is judged that the red eye candidate is highly likely to be a true red eye, and the red eye candidate is estimated to be a red eye. On the other hand, if the total number is the predetermined number or less, it is judged that the red eye candidate was a false positive detection, and that it is not a true red eye. In this case, the red eye detecting apparatus deletes information regarding the red eye candidate from every list that it is registered in.

In the case that red eye candidates are estimated to be red eyes, the red eye estimating step 3 then confirms the positions of the red eyes. As described above, if judgments are performed by scanning the judgment target region within the search regions, positive judgments are obtained at many judgment target regions. Therefore, the red eye detecting apparatus of the present invention defines a weighted average of the center coordinates of the judgment target regions, in which positive judgments were obtained, as the value that represents the position of the red eye. The weighting is performed corresponding to the total score, which was obtained during judgment, of the judgment target regions.

FIG. 22 is a diagram for explaining the method by which the positional coordinates of red eyes are confirmed. FIG. 22 illustrates the search region 22 and the center coordinates (indicated by x's) of the judgment target regions in which positive judgments were obtained. In the example of FIG. 22, positive judgments were obtained for M (M is an arbitrary integer, in this case, 48) judgment target regions. In this case, the position (x, y) of the red eye is represented by the following formulas:

$$x = ( {\sum }_{i = 0}^{i < M} Sixi ) / M$$

$$y = ( {\sum }_{i = 0}^{i < M} Siyi ) / M$$

wherein (xi, yi) are the center coordinates of an i-th judgment target region (0≦i<M), and Si is the total score obtained by the red eye judgment processes in the i-th judgment target region.

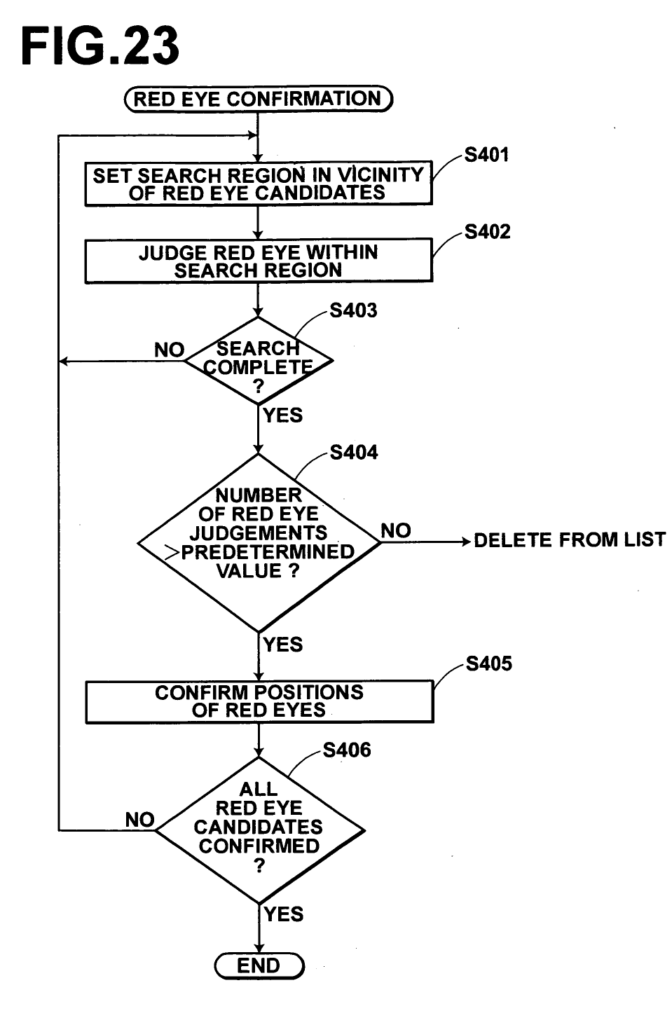

FIG. 23 is a flow chart that illustrates processes of the red eye estimating step 3. As illustrated in the flow chart, the first process in the red eye estimating step is the setting of search regions in the vicinities of red eye candidates (step S401). Next, red eye judgment, as has been described with reference to FIGS. 19 through 21, is performed within the search regions (step S402). When the searching within the search regions is completed (step S403), the number of positive judgments is compared against the predetermined number (step S404). In the case that the number of positive judgments is less than or equal to the predetermined number, the red eye candidate is deleted from the list. In the case that the number of positive judgments is greater than the predetermined number, the red eye candidate is estimated to be a red eye, and the position thereof is confirmed (step S405) by the process described with reference to FIG. 22. The red eye estimating step 3 is completed when the above processes are completed for all of the red eye candidates detected in the red eye candidate detecting step 1.

Note that the characteristic amounts, the score tables, and the threshold values, which are employed in the red eye estimating step 3 may be the same as those which are employed in the red eye candidate detecting step 1. Alternatively, different characteristic amounts, score tables, and threshold values may be prepared for the red eye estimating step 3.

In the case that different characteristic amounts, score tables, and threshold values are defined for the red eye estimating step 3, only images that represent standard red eyes are employed as sample images during learning. That is, learning is performed using only sample images of red eyes having similar sizes and orientations. Thereby, detection is limited to true red eyes, and the accuracy of judgment is improved.

In the red eye candidate detecting step 1, it is preferable that the variation among sample images, which are employed during learning, is not decreased, because a decrease in variation would lead to red eye candidates not being detected. However, the red eye estimating step 3 is a process that verifies the detection results of the red eye candidate detecting step 1, and employs search regions in the vicinities of the detected red eye candidates. Therefore, the variation among sample images, which are employed during learning, may be comparatively small. In the red eye estimating step 3, the smaller the variation in sample images, which are employed during learning, the stricter the judgment standards become. Therefore, the accuracy of judgment is improved over that of the red eye candidate detecting step 1.

The method of the present embodiment requires the three steps of: red eye candidate detection; face detection; and red eye estimation. Therefore, it may appear that the number of processes is increased compared to conventional methods. However, the amount of calculations involved in the red eye estimating step 3 is far less than that involved in characteristic extraction processes administered on faces. In addition, because the search regions are limited to the vicinities of red eye candidates, neither the amount of processing nor the complexity of the apparatus are greatly increased compared to conventional methods and apparatuses.

[Result Confirming Step 4]

Next, the result confirming step 4 will be described. The foregoing three step process comprising the red eye candidate detecting step 1, the face detecting step 2, and the red eye estimating step 3 yields results that indicate that there are no red eyes in the image S, or that there are red eye candidates, which are highly likely to be red eyes and which have been estimated to be red eyes, in the image S. The result confirming step 4 confirms whether the red eye candidates, which have been estimated to be red eyes, are true red eyes. Specifically, the result confirming step 4 judges whether the red eye candidates which have been estimated to be red eyes are the corners of eyes, and confirms the results based on the results of this judgment. Hereinafter, two examples of methods, by which it is judged whether the red eye candidates estimated to be red eyes are the corners of eyes, will be described.

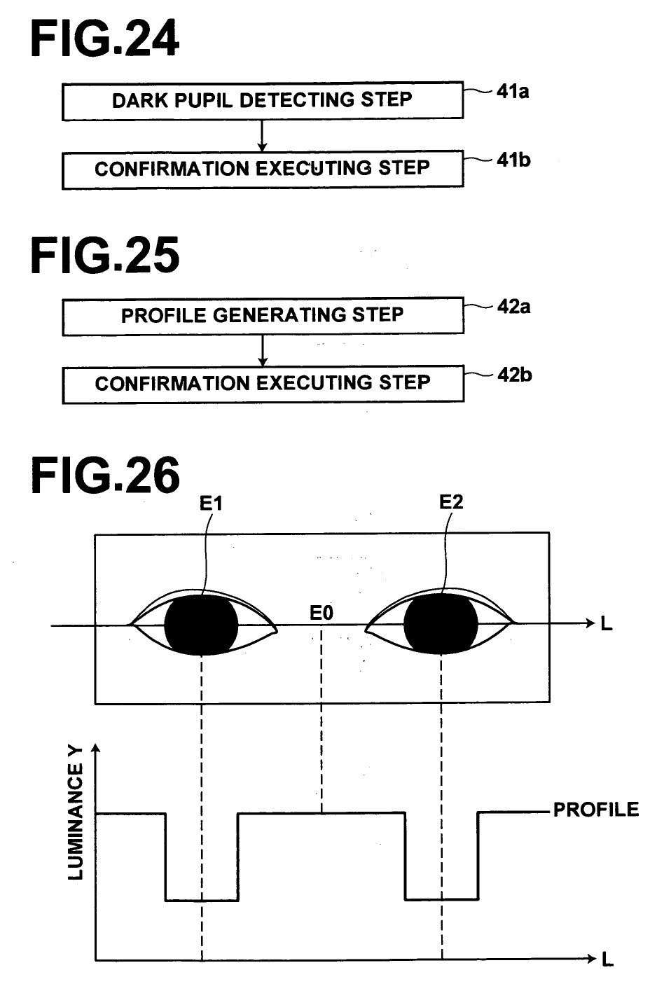

FIG. 24 is a flow chart that illustrates the processing steps of a first method. As illustrated in FIG. 24, the first method judges whether the red eye candidates, which have been estimated to be red eyes in the red eye estimating step 3 (for example, the red eye candidates 7a and 7b of FIG. 2), are true red eyes, with a dark pupil detecting step 41a and a confirmation executing step 41b. The red eye estimating step 3 performs red eye judgment processes on the red eye candidates obtained by the red eye candidate detecting step 1, at a higher accuracy than that employed during the red eye candidate detecting step 1. In addition, the red eye estimating step 3 deletes red eye candidates that are positioned at locations where eyes should not be. Accordingly, the red eye candidates which have been estimated to be red eyes by the red eye estimating step 3 are at positions where eyes should be. However, red portions of the corners of eyes (portion A and portion B of FIG. 31) are also present at positions where eyes should be. Therefore, in the case of photographic images of people for whom these portions are large, red portions, such as portion A and portion B illustrated in FIG. 31, may be estimated to be red eyes to cause false positive detection of red eyes, even if red eyes are not present.

Meanwhile, in photographic images in which pupils are not pictured as red eyes, dark pupils, which are pictured as their original colors, should be present. The first method pays attention to this fact, and performs the dark pupil detecting step 41a within the face detected by the face detecting step 2. Various known methods may be employed in the dark pupil detecting step. For example, the method employed in the aforementioned red eye candidate detecting step 1 or the method employed in the red eye estimating step 3 may be applied. Here, it is preferable for the method employed in the red eye estimating step 3 to be applied, in order to increase the accuracy of the dark pupil detecting step 41a. Note that in the dark pupil detecting step 41a, the procedures are the same as those employed in the red eye candidate detecting step 1 and the red eye estimating step 3, except that the sample images utilized for learning are sample images of dark pupils instead of red eyes. Therefore, a detailed description of the specific procedures will be omitted.

The confirmation executing step 41b confirms the results of estimation by the red eye estimating step 3, based on the detection results of the dark pupil detecting step 41a. Specifically, if dark pupils are detected in the dark pupil detecting step 41a, the confirmation executing step 41b judges that the red eye candidates estimated to be red eyes in the red eye estimating step 3 are the corners of eyes (more accurately, the red portions at the corners of the eyes), and that the estimation results are erroneous. On the other hand, if dark pupils are not detected in the dark pupil detecting step 41a, the confirmation executing step 41b judges that the red eye candidates estimated to be red eyes in the red eye estimating step 3 are not the corners of eyes, but true red eyes. In the case that it is judged that the results of estimation are erroneous, the confirmation executing step 41b outputs data indicating that red eyes have not been detected as the detection results K. In the case that it is judged that the results of estimation are correct, the confirmation executing step 41b outputs the positional coordinate data of the red eyes, which have been estimated as being red eyes by the red eye estimating step 3, as the detection results K.

FIG. 25 is a flow chart that illustrates the processing steps of a second method. As illustrated in FIG. 25, the second method judges whether the red eye candidates, which have been estimated to be red eyes in the red eye estimating step 3, are true red eyes, with a profile generating step 42a and a confirmation executing step 42b. The profile generating step 42a will be described with reference to FIG. 26.

The profile generating step 42a generates a pixel value profile of pixels along a straight line that connects two red eye candidates, which have been estimated to be red eyes by the red eye estimating step 3. Here, the length of the straight line is not the length between the left and right ends of the two red eye candidates. The straight line extends to the edges of the contour of the face detected by the face detecting step 2. In addition, luminance values Y are employed as the pixel values. FIGS. 26, 27, and 28 illustrate examples of pixel value profiles generated by the profile generating step 42a. In each of FIGS. 26, 27, and 28, the horizontal axis L represents the positions of pixels along the straight line that connects the two red eye candidates (denoted by E1 and E2), and the vertical axis represents the luminance Y of the pixel at each position along the horizontal axis L. Note that the positions denoted by E0 in FIGS. 26, 27, and 28 are the center positions between the positions E1 and E2 of the two red eye candidates.

The confirmation executing step 42b employs the pixel value profile generated in the profile generating step 42a, to confirm whether the red eye candidates, which have been estimated to be red eyes in the red eye estimating step 3, are the corners of eyes.

FIG. 26 illustrates an example of a pixel value profile in the case that the two red eye candidates are not the corners of eyes, but are true red eyes. As illustrated in FIG. 26, the pixel value profile has its deepest valleys at the positions E1 and E2 of the red eye candidates, and no deeper valleys are present at either the exterior or the interior of the two valleys.

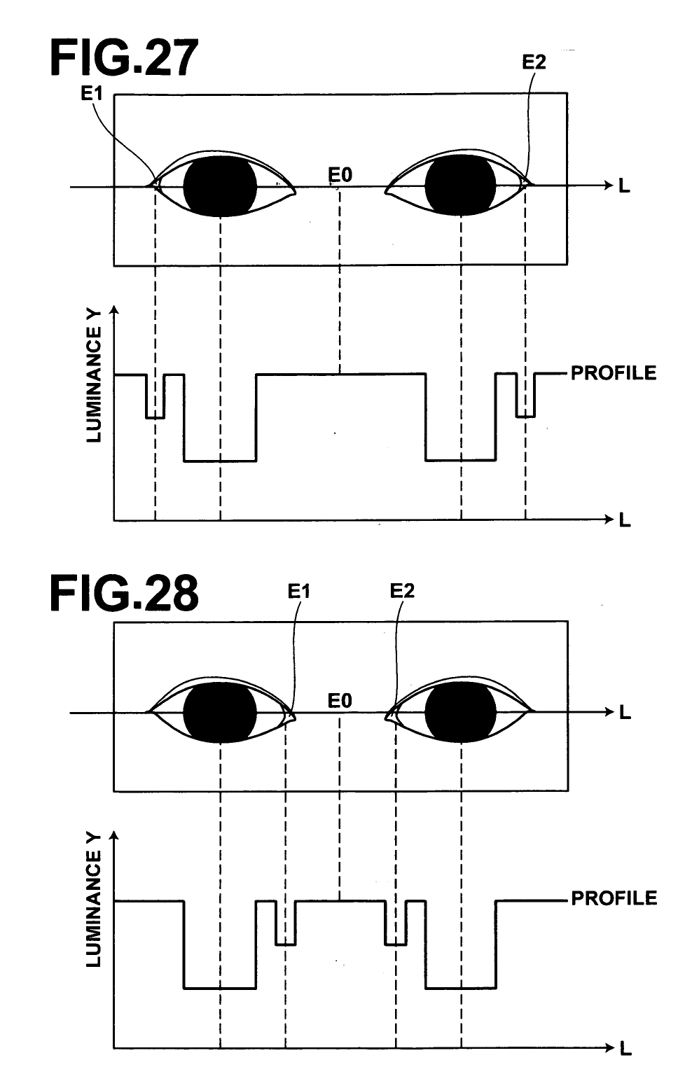

FIG. 27 illustrates an example of a pixel value profile in the case that the two red eye candidates are the outer corners of eyes. As illustrated in FIG. 27, the pixel value profile has valleys at the positions E1 and E2 of the red eye candidates. However, two valleys having even lower luminance values than those at the positions E1 and E2 are present toward the interior of the two valleys, symmetrical with respect to the center position E0. Note that the two deeper valleys having the lower luminance values than those at the positions E1 and E2 are formed by the presence of dark pupils.

FIG. 28 illustrates an example of a pixel value profile in the case that the two red eye candidates are the inner corners of eyes. As illustrated in FIG. 28, the pixel value profile has valleys at the positions E1 and E2 of the red eye candidates. However, two valleys having even lower luminance values than those at the positions E1 and E2 are present toward the exteriors of the two valleys, symmetrical with respect to the center position E0. Note that the two deeper valleys having the lower luminance values than those at the positions E1 and E2 are formed by the presence of dark pupils.

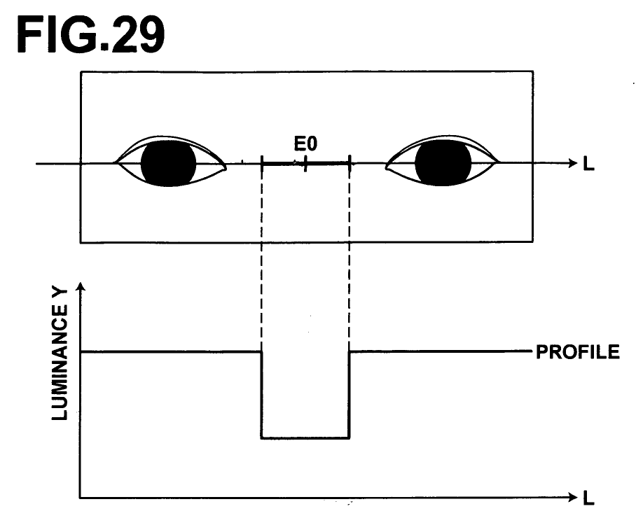

The confirmation executing step 42b performs confirmation employing the pixel value profiles. However, prior to performing the confirmation, the confirmation executing step 42b removes continuous valleys that include the center position E0, as a preliminary process. In the case that a person pictured in an image is wearing dark colored glasses, a continuous valley is generated having the center position E0 as its center, as illustrated in FIG. 29. Therefore, the influence of glasses can be removed by the preliminary process.

The confirmation executing step 42b confirms whether the generated pixel value profile is one of the three profiles illustrated in FIG. 26, FIG. 27, and FIG. 28, after the preliminary process is administered thereon. If the pixel value profile is that illustrated in FIG. 26, the confirmation executing step 42b judges that the red eye candidates estimated to be red eyes in the red eye estimating step 3 are not the corners of eyes, that is, that the results of estimation are correct. In this case, the positional coordinate data of the red eye candidates estimated to be red eyes in the red eye estimating step 3 are output as detection results K. On the other hand, if the pixel value profile is that illustrated in either FIG. 27 or FIG. 28, it is judged that the red eye candidates estimated to be red eyes in the red eye estimating step 3 are either the inner or outer corners of eyes, that is, that the results of estimation are erroneous. In this case, data that indicates that red eyes have not been detected is output as detection results K.

The red eye detecting apparatus of the present embodiment may employ either of the two methods described above to confirm the results of estimation by the red eye estimating step 3.

[Utilization of the Detection Results]

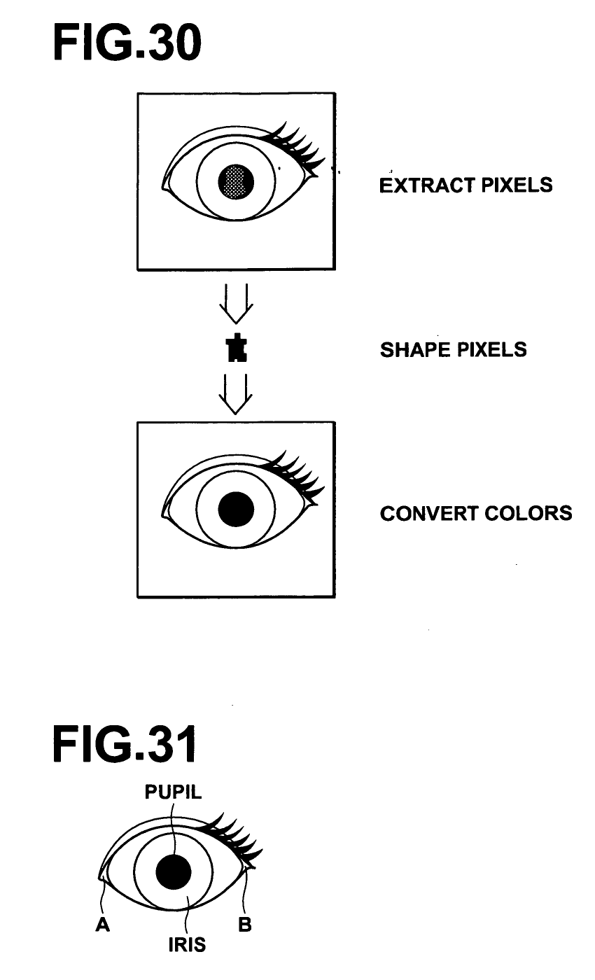

The red eye detection results are utilized to correct red eye, for example. FIG. 30 illustrates an example of a red eye correcting process. In the exemplary process, first, pixels, of which the color difference value Cr exceeds a predetermined value, are extracted. Then, a morphology process is administered to shape the extracted region. Finally, the colors of each pixel that constitute the shaped region are replaced with colors which are appropriate for pupils (such as a gray of a predetermined brightness).

Note that other known methods for correcting red eyes within images may be applied as well. Examples of such methods are disclosed in Japanese Unexamined Patent Publication Nos. 2000-013680 and 2001-148780.

An alternative embodiment may be considered in which red eye is not corrected, but a warning is issued indicating that a red eye phenomenon has occurred. For example, a red eye detecting function may be incorporated into a digital camera. The red eye detecting process may be executed on an image immediately following photography thereof, and an alarm that suggests that photography be performed again may be output from a speaker in the case that red eyes are detected.

According to the present invention, false positive detection of red eyes can be prevented, by judging whether the detected red eye candidates are the corners of eyes.

The purpose of red eye detection in the present invention is to correct red eye. Generally, images in which dark pupils are pictured (that is, normal images) outnumber images in which red eye occurs. Therefore, dark pupils are detected after red eye candidates are estimated to be red eyes, and whether the red eye candidates are the corners of eyes is judged, in order to detect red eyes efficiently. Alternatively, dark pupils may be detected prior to detecting red eye candidates, and images in which dark pupils are detected may be judged to not have red eye, while the red eye candidate detection step may be administered only on images in which dark pupils are not detected.

The red eye detecting apparatus of the present invention is not limited to the embodiments described above. Various changes and modifications are possible, as long as they do not depart from the spirit of the present invention. For example, red eye detection in human faces was described in the above embodiments. However, the present invention is applicable to abnormally pictured eyes of animals other than humans. That is, faces of animals can be detected instead of human faces, and green eyes or silver eyes of the animals may be detected instead of the red eyes of humans.

What is claimed is:

1. A red eye detecting method for detecting red eyes, comprising the steps of:
detecting red eye candidates, by discriminating characteristics inherent to pupils, of which at least a portion is displayed red, from within an image;
detecting faces that include the red eye candidates, by discriminating characteristics inherent to faces, from among characteristics of the image in the vicinities of the red eye candidates;
estimating that the red eye candidates included in the detected faces are red eyes; and
confirming the results of estimation, by judging whether the red eye candidates are the corners of eyes.

2. A red eye detecting method as defined in claim 1, wherein the estimating step is realized by:
discriminating characteristics inherent to pupils, of which at least a portion is displayed red, from the characteristics of the image in the vicinities of the red eye candidates at a higher accuracy than that employed during the detection of the red eye candidates; and
estimating that the red eye candidates having the characteristics are red eyes.

3. A red eye detecting method as defined in claim 1, wherein the red eye candidates are detected by:
setting judgment target regions within the image;
obtaining characteristic amounts that represent characteristics inherent to pupils having regions displayed red from within the judgment target regions;
calculating scores according to the obtained characteristic amounts; and
judging that the image within the judgment target region represents a red eye candidate when the score is greater than or equal to a first threshold value; and
confirming the results of estimation only for red eye candidates, of which the score is less than a second threshold value, which is greater than the first threshold value.

4. A red eye detecting method as defined in claim 3, further comprising the steps of:
defining characteristic amounts that represent likelihood of being a dark pupil, a score table, and a threshold value, by learning sample images of dark pupils and sample images of subjects other than dark pupils, with a machine learning technique;
calculating the characteristic amounts from within the judgment target regions;
calculating scores corresponding to the characteristic amounts according to the score table; and
detecting dark pupils, by judging that the image within the judgment target region represents a dark pupil when the score is greater than or equal to the threshold value.

5. A red eye detecting method as defined in claim 1, wherein:
a pixel value profile is obtained, of pixels along a straight line that connects two red eye candidates, which have been estimated to be red eyes; and
the judgment regarding whether the red eye candidates are the corners of eyes is performed employing the pixel value profile.

6. A red eye detecting method as defined in claim 5, wherein:
the judgment is performed by confirming which profile the pixel value profile is, from among: a profile in the case that the two red eye candidates are true red eyes; a case that the two red eye candidates are the inner corners of eyes; and a case that the two red eye candidates are the outer corners of eyes.

7. A red eye detecting apparatus, comprising:
red eye candidate detecting means for detecting red eye candidates, by discriminating characteristics inherent to pupils, of which at least a portion is displayed red, from within an image;
face detecting means for detecting faces that include the red eye candidates, by discriminating characteristics inherent to faces, from among characteristics of the image in the vicinities of the red eye candidates;
red eye estimating means for estimating that the red eye candidates included in the detected faces are red eyes; and
result confirming means for confirming the results of estimation, by judging whether the red eye candidates are the corners of eyes.

8. A red eye detecting apparatus as defined in claim 7, wherein:
the red eye estimating means discriminates characteristics inherent to pupils, of which at least a portion is displayed red, from the characteristics of the image in the vicinities of the red eye candidates at a higher accuracy than that employed during the detection of the red eye candidates; and estimates that the red eye candidates having the characteristics are red eyes.

9. A red eye detecting apparatus as defined in claim 7, wherein the red eye candidate detecting means detects red eye candidates by:
setting judgment target regions within the image;
obtaining characteristic amounts that represent characteristics inherent to pupils having regions displayed red from within the judgment target regions;
calculating scores according to the obtained characteristic amounts; and
judging that the image within the judgment target region represents a red eye candidate when the score is greater than or equal to a first threshold value; and
the result confirming means confirms the results of estimation only for red eye candidates, of which the score is less than a second threshold value, which is greater than the first threshold value.

10. A red eye detecting apparatus as defined in claim 9, wherein:
the result confirming means further comprises dark pupil detecting means for detecting dark pupils within the face region detected by the face detecting means; and
the judgment regarding whether the red eye candidates, which have been estimated to be red eyes, are the corners of eyes is judged in the case that dark pupils are detected.

11. A red eye detecting apparatus as defined in claim 10, wherein the dark pupil detecting means detects dark pupils by:
defining characteristic amounts that represent likelihood of being a dark pupil, a score table, and a threshold value, by learning sample images of dark pupils and sample images of subjects other than dark pupils, with a machine learning technique;
calculating the characteristic amounts from within the judgment target regions;
calculating scores corresponding to the characteristic amounts according to the score table; and
judging that the image within the judgment target region represents a dark pupil when the score is greater than or equal to the threshold value.

12. A red eye detecting apparatus as defined in claim 7, wherein:
the result confirming means comprises a profile obtaining means for obtaining a pixel value profile of pixels along a straight line between two red eye candidates, which have been estimated to be red eyes by the red eye estimating means; and
the judgment regarding whether the red eye candidates are the corners of eyes is performed employing the pixel value profile obtained by the profile obtaining means.

13. A red eye detecting apparatus as defined in claim 12, wherein:
the result confirming means judges whether the red eye candidates are the corners of eyes, by confirming which profile the pixel value profile is, from among: a profile in the case that the two red eye candidates are true red eyes; a case that the two red eye candidates are the inner corners of eyes; and a case that the two red eye candidates are the outer corners of eyes.

14. A computer readable medium having a red eye detecting program recorded therein that causes a computer to execute:
a red eye candidate detecting procedure for detecting red eye candidates, by discriminating characteristics inherent to pupils, of which at least a portion is displayed red, from within an image;
a face detecting procedure for detecting faces that include the red eye candidates, by discriminating characteristics inherent to faces, from among characteristics of the image in the vicinities of the red eye candidates;
a red eye estimating procedure for estimating that the red eye candidates included in the detected faces are red eyes; and
a result confirming procedure for confirming the results of estimation, by judging whether the red eye candidates are the corners of eyes.

15. A computer readable medium as defined in claim 14, wherein:
the red eye estimating procedure discriminates characteristics inherent to pupils, of which at least a portion is displayed red, from the characteristics of the image in the vicinities of the red eye candidates at a higher accuracy than that employed during the detection of the red eye candidates; and estimates that the red eye candidates having the characteristics are red eyes.

16. A computer readable medium as defined in claim 14, wherein the red eye candidate detecting procedure detects red eye candidates by:
setting judgment target regions within the image;
obtaining characteristic amounts that represent characteristics inherent to pupils having regions displayed red from within the judgment target regions;
calculating scores according to the obtained characteristic amounts; and
judging that the image within the judgment target region represents a red eye candidate when the score is greater than or equal to a first threshold value; and
the result confirming procedure confirms the results of estimation only for red eye candidates, of which the score is less than a second threshold value, which is greater than the first threshold value.

17. A computer readable medium as defined in claim 16, wherein:
the result confirming procedure detects dark pupils within the face region detected by the face detecting procedure; and
the judgment regarding whether the red eye candidates, which have been estimated to be red eyes, are the corners of eyes is judged in the case that dark pupils are detected.

18. A computer readable medium as defined in claim 17, wherein the result confirming procedure detects the dark pupils by:
defining characteristic amounts that represent likelihood of being a dark pupil, a score table, and a threshold value, by learning sample images of dark pupils and sample images of subjects other than dark pupils, with a machine learning technique;
calculating the characteristic amounts from within the judgment target regions;
calculating scores corresponding to the characteristic amounts according to the score table; and
judging that the image within the judgment target region represents a dark pupil when the score is greater than or equal to the threshold value.

19. A computer readable medium as defined in claim 14, wherein:
the result confirming procedure comprises the step of obtaining a pixel value profile of pixels along a straight line between two red eye candidates, which have been estimated to be red eyes by the red eye estimating means; and
the judgment regarding whether the red eye candidates are the corners of eyes is performed employing the obtained pixel value profile.

20. A computer readable medium as defined in claim 19, wherein:
the result confirming procedure judges whether the red eye candidates are the corners of eyes, by confirming which profile the pixel value profile is, from among: a profile in the case that the two red eye candidates are true red eyes; a case that the two red eye candidates are the inner corners of eyes; and a case that the two red eye candidates are the outer corners of eyes.
